(19) United States
(12) Patent Application Publication
(10) Pub. No.: US 2008/0187260 A1
(43) Pub. Date: Aug. 7, 2008

(54) COMPOSITE ANTIFRICTION BEARING MATERIAL

(75) Inventors: Werner Schubert, Weisloch (DE); Friedhelm Gerlach, Westoverledingen (DE); Dipl.-Ing Gerhard Caspers, Bad Schoenborn (DE); Megjit Seremeti G-PPP-3, Papenburg (DE); Bernhard Rehbock, Papenburg (DE)

Correspondence Address: BRINKS HOFER GILSON & LIONE, P.O. BOX 10395, CHICAGO, IL, 60610, US

(73) Assignee: KS Gleitlager GmbH, St. Leon-Rot (DE)

(21) Appl. No.: 12/050,856

(22) Filed: Mar. 18, 2008

Related U.S. Application Data
(63) Continuation of application No. PCT/EP2006/005632, filed on Jun. 13, 2006.

(30) Foreign Application Priority Data
Sep. 20, 2005 (DE) 10 2005 045 701.0

(51) Int. Cl. F16C 9/02

(52) U.S. Cl. 384/294

(57) ABSTRACT

The invention relates to a composite antifriction bearing material for producing antifriction bearing elements, in particular antifriction bearing bushes and antifriction bearing half liners for engine applications, comprising a steel carrier layer and a copper-based, in particular copper-tin-based or copper-zinc-based bearing metal layer applied on top, and comprising an aluminum-based running layer sputtered onto the bearing metal layer; to improve the running-in behavior, applied to the sputtered-on running layer is an additional running-in layer, which is either a zinc-phosphate layer 1-5 μm thick formed on the surface of the running layer or a layer of tin, bismuth, silver or alloys thereof 1-5 μm thick sputtered onto the running layer, but softer than the latter, or a polymer-based antifriction coating less than 10 μm thick.

### CROSS-REFERENCE TO RELATED APPLICATIONS

This application is a continuation of International Application No. PCT/EP2006/005632 filed on Jun. 13, 2006, which claims the benefit of DE 10 2005 045 701.0, filed Sep. 20, 2005. The disclosures of the above applications are incorporated herein by reference.

### FIELD

The invention relates to a sliding bearing composite material for manufacturing sliding bearing elements, and more particularly, to a sliding bearing composite material for manufacturing sliding bearing elements for motor applications.

### BACKGROUND

The statements in this section merely provide background information related to the present disclosure and may not constitute prior art.

Sliding bearing composite materials with a sputtered-on running layer on an aluminum base are known, for example from German Patent DE 103 60 818 A. By providing a sputter layer on the carrying bearing metal layer, one can achieve great hardness and resistance to wear and tear of the sliding bearing composite material and a sliding element manufactured therefrom.

Plain bearing bushes are understood to include any rolled plain bearing bushes for any desired sliding bearing applications. Sliding bearing composite material is to a great extent suited for manufacturing heavily loaded connecting rod bearing bushes, in other words, bushes for bedding the piston pin in the small connecting rod eye of an engine connecting rod. There the plain bearing bush is exposed to extreme temperatures and stresses, but rather moderate sliding speeds.

Plain bearing half liners for motor applications are generally meant to include shells bent into a semicircular form for divided bearing sites, especially for the bedding of the connecting rod on the crankshaft journal or the crankshaft in the crankcase in an internal combustion machine. The operating temperatures are lower with these applications than with connecting rod bearing bushes. The sliding speeds are, however, considerably higher in relation thereto.

Although sliding bearing composite materials with sputtered on sliding or running layers are suited for the highest stresses in the operation of internal combustion engines, there still exists a potential for improvements with respect to the run-in behavior if the pairing of sliding bearing element and sliding partner are thus adjusted to each other. Improvements are also possible in operation in case of insufficient lubrication.

### SUMMARY

In one aspect, the present invention provides sliding bearing composite material for manufacturing sliding bearing elements. The material includes a carrier layer of steel, a copper-based bearing metal layer applied to the carrier layer of steel, an aluminum-based running layer sputtered on the bearing metal layer, and a run-in layer applied to the aluminum based running layer. The run-in layer is one of the following: a zinc-phosphate layer having a thickness of about 1-5 μm formed on the surface of the running layer, a layer of tin, bismuth, silver, or alloys thereof having a thickness of about 1-5 μm sputtered on the surface of the running layer, and a polymer-based slip varnish layer having a thickness of less than 10 μm.

In another aspect, the present invention provides a plain bearing half liner comprising a sliding bearing composite material. The composite material may be provided as described above.

In yet another aspect, the present invention provides a sliding bearing bush manufactured from a sliding bearing composite material. The composite material may be provided as described above.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

It is thus proposed in accordance with the present invention that the sputtered-on running layer, which is suited for the highest standards on a tribologically favorable surface condition, not be provided directly for a contact with the sliding partner, but rather an additional run-in layer is provided on this hard running layer. Run-in layers for sliding bearings are inherently known. But high-grade sliding bearings with sputtered-on running layers have been avoided because it was assumed that in this way the high-grade properties of the sputtered-on running layer would be negatively influenced.

But it has now turned out that this does not represent a disadvantage, and does not negatively influence but rather supports the operating behavior of such sliding bearing composite materials or sliding bearing elements manufactured from them, especially connecting rod bearing bushes, connecting rod bearing shells and crankshaft bearing bushes in internal combustion engines, since the run-in behavior of these sliding bearing elements was improved.

In one form of the invention, a sliding bearing composite material for manufacturing sliding bearing elements is provided. The material may be used to form plain bearing bushes and plain bearing half liners for motor applications, by way of example.

The composite material includes a carrier layer of steel and a copper-based bearing metal layer applied thereupon. The copper-based material could have a copper-tin or copper-zinc base, by way of example. An aluminum-based running layer is sputtered on the bearing metal layer, and an additional run-in layer is applied to the sputtered-on running layer. The additional run-in layer is either a zinc-phosphate layer with a thickness from 1-5 μm formed on the surface of the running layer, or a layer of tin, bismuth, silver or alloys thereof with a thickness from 1-5 μm sputtered on the surface of the running layer but softer in relation to it, or a polymer-based slip varnish layer with a thickness of less than 10 μm.

In some variations, the bearing metal layer may be a copper-zinc alloy with about 10-32% by weight Zn. In some variations, the alloy could be provided with about 10-25% by weight Zn, and in others, with 1-8% by weight Ni. The bearing metal layer may be constructed lead-free. In some variations, the hardness of the bearing metal layer amounts to 110-150 HV 0.002; or it may amount to 110-140 HV 0.002; or it may amount to 110-130 HV 0.002, by way of example.

The aluminum-based running layer may be formed by an aluminum-tin alloy with 20-30% by weight Sn, and in some variations, 20-26% by weight of Sn. In other variations, the aluminum-based running layer may be an aluminum-zinc alloy, and it may include up to 2% by weight Ni, Si, and Mn. Further, it may include impurity-conditioned components up to respectively 0.5% by weight in total but not more than 1% by weight. The aluminum-zinc alloy may have the composition AlSn (20-30) Cu (2.3-2.8), or AlSn (23-27) Cu (2.3-2.8), or AlSn20Cu, by way of example. In some variations, the aluminum-based running layer may be formed by an aluminum-zinc alloy with 3-6% by weight zinc. Further, it may contain if need be with 1-5% by weight bismuth. In some variations, the bismuth is provided as 2-4% by weight.

As stated above, in some forms, the additional run-in layer may be a zinc-phosphate layer. The zinc-phosphate layer may be formed on or in connection with the sputtered-on running layer. This can be attained by dipping the sliding bearing composite material or the sliding bearing elements, which have already been brought into their final form, especially plain bearing bushes or plain bearing half liners, into a phosphatizing solution, as described in EP 0 399 425 B1.

In another form of the invention, one can use an additional sputtered-on layer as run-in later, which, however, is softer than the running layer, in order thus to function as a run-in layer.

In yet another form of the invention, a thin polymer-based run-in layer can also be used. Further preferred compositions of this slip varnish layer will become apparent from the dependent claims.

If a slip varnish layer is used as the additional run-in layer, it may be PTFE-free and formed on the basis of PAI (polyamideimide). It may have a thickness of preferably less than 10 μm, in some variations at most 8 μm, and in some variations at most 6 μm. The slip varnish layer may include about 5-15% by weight of zinc sulfide, about 5-15% by weight of graphite and about 5-15% by weight of TiO₂, whereby zinc sulfide and TiO₂ are preferably present in a particle size of ≦0.7 μm. Barium sulfate could also be used instead of zinc sulfide.

It was established in accordance with the invention that PTFE, inherently proved itself with respect to its tribological properties, in connection with PAI (polyamideimide)-based varnish layers makes bonding to a bearing metal layer difficult precisely in connection with thin coatings. Further, it was discovered that a PTFE-free varnish coat, even when it is very thin, can adhere considerably better on the sputtered-on running layer, specifically also under strong stress. Moreover, an addition of zinc sulfide, graphite and titanium dioxide, respectively, in the stressed region has proven itself as preeminently suited in cooperation with PAI. Zinc sulfide is a good solid lubricant which is not sensitive to dryness. In this respect, graphite is more sensitive, but on the other hand has good heat conductivity and is capable of deflecting the occurring friction heat in the direction of the bearing metal layer and the metallic support layer. Titanium dioxide, in contrast, imparts the required resistance to wear and tear. Consequently, these components create a suitable system in tribologic terms even under conditions of mixed friction (high load, occurring friction heat, dryness).

It has proven advantageous when zinc sulfide (or barium sulfide), graphite and TiO₂ are in each case present to the extent of 7 to 13% by weight. It has also proven practical when the percent-by-weight ratio of zinc sulfide (or barium sulfide) and graphite, respectively, to TiO₂ lies between 0.6 and 1.4, especially between 0.7 and 1.3. In the preferred case, providing approximately the same percentage by weight amounts of zinc sulfide (or barium sulfide), graphite and TiO₂ in the varnish layer is proposed.

In terms of good bonding to the bearing metal layer, it is advantageous when the varnish layer is fluoro-polymer-free.

It has moreover proved advantageous that the PAI be well soluble, for example in NMP (ratio approximately 1:1), and that the varnish layer can thus be applied as a solution, in particular, be sprayed on.

Zinc sulfide and titanium dioxide are preferably present as very fine particles since in this way a very “dense” homogeneous distribution of these substances in the matrix consisting of PAI can be attained. They have preferably a D50 value with a particle size between 200 nm and 500 nm. The previously mentioned D50 value of particle size designates a particle size regarding the 50% by weight of the particular substance, with a comparatively larger particle size and 50% by weight with a comparatively smaller particle size.

The present invention does not rule out that, in addition to PAI as a matrix forming plastic component of the varnish layer, one or more additional matrix-forming plastics may be contained. Their proportion should, however, not amount to more than 20% by weight, and more preferably not more than 10% by weight of the share of PAI in the varnish layer. Preferably the matrix is formed of PAI to the extent of 100%. Advantageously the varnish layer may contain about 5-15% by weight of one of zinc sulfide and barium sulfate, about 5-15% by weight of graphite, and about 5-15% by weight of TiO₂. The zinc sulfide or barium sulfate and the TiO₂ may be present in a particle size of ≦0.7 μm. In some variations, the zinc sulfide or barium sulfate and TiO₂ may be present in a particle size of ≦0.6 μm, or even ≦0.5 μm.

In another form of the invention, a plain bearing half liner having a sliding bearing composite material is provided. The composite material may have components such as any of those described above. For example, the composite material may include a carrier layer of steel, a copper-based bearing metal layer applied to the carrier layer of steel, an aluminum-based running layer sputtered on the bearing metal layer, and a run-in layer applied to the aluminum based running layer. The run-in layer, also described above as the additional run-in layer, could be formed as any of the variations described above. The plain bearing half liner may be installed in a combustion engine as one of a connecting rod bearing shell and a crankshaft bearing bush.

In yet another form of the invention, a sliding bearing bush manufactured from a sliding bearing composite material is provided. The composite material may be formed in any variation described above. The sliding bearing bush may be installed in a combustion engine as a connecting rod bearing bush.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. Sliding bearing composite material for manufacturing sliding bearing elements comprising:
a carrier layer of steel;
a copper-based bearing metal layer applied to the carrier layer of steel;
an aluminum-based running layer sputtered on the bearing metal layer; and
a run-in layer applied to the aluminum based running layer, the run-in layer being one of the following: a zinc-phosphate layer having a thickness of about 1-5 μm formed on the surface of the running layer, a layer of tin, bismuth, silver, or alloys thereof having a thickness of about 1-5 μm sputtered on the surface of the running layer, and a polymer-based slip varnish layer having a thickness of less than 10 μm.

2. The sliding bearing composite material according to claim 1, wherein the bearing metal layer is a copper-zinc alloy with about 10-32% by weight zinc.

3. The sliding bearing composite material according to claim 1, wherein the bearing metal layer is lead-free.

4. The sliding bearing composite material according to claim 1, wherein the hardness of the bearing metal layer amounts to 110-150 HV 0.002.

5. The sliding bearing composite material according claim 1, wherein the running layer is formed by an aluminum-tin alloy with about 20-30% by weight tin.

6. The sliding bearing composite material according to claim 1, wherein the running layer is an aluminum-zinc alloy that includes up to 2% by weight Ni, Si, and Mn.

7. The sliding bearing composite material according to claim 1, wherein the running layer is an aluminum-tin alloy having the composition AlSn (20-30) Cu (2.3-2.8).

8. The sliding bearing composite material according to claim 1, wherein the running layer is formed by an aluminum-zinc alloy with about 3-6% by weight zinc and about 1-5% by weight bismuth.

9. The sliding bearing composite material according to claim 1, wherein the run-in layer is the polymer-based slip varnish layer having a thickness of less than 10 μm, the slip varnish layer being PTFE-free and being built on the base of PAI.

10. The sliding bearing composite material according to claim 1, wherein the run-in layer is the polymer-based slip varnish layer having a thickness of less than 10 μm.

11. The sliding bearing composite material according to claim 1, wherein the run-in layer is the polymer-based slip varnish layer having a thickness of less than 10 μm, the slip varnish layer including about 5-15% by weight of one of zinc sulfide and barium sulfate, about 5-15% by weight of graphite, and about 5-15% by weight of TiO₂, the one of zinc sulfide and barium sulfate and the TiO₂ being present in a particle size of ≦0.7 μm.

12. The sliding bearing composite material according to claim 11, the slip varnish layer including about 7-13% by weight of one of zinc sulfide and barium sulfate, about 7-13% by weight of graphite, and about 7-13% by weight of TiO₂,

13. The sliding bearing composite material according to claim 11, wherein the percentage-by-weight ratio of the one of zinc sulfide and barium sulfate and of the graphite, respectively, to the TiO₂ amounts to 0.6-1.4%.

14. The sliding bearing composite material according to claim 11, wherein the one of zinc sulfide and barium sulfate and the TiO₂ are present in a particle size of ≦0.6 μm.

15. The sliding bearing composite material according to claim 11, wherein the D50 value of the particle size of the one of zinc sulfide and barium sulfate and the TiO₂ lies between about 200 nm and 500 nm.

16. The sliding bearing composite material according to claim 1, wherein the run-in layer is the polymer-based slip varnish layer having a thickness of less than 10 μm, the varnish layer being fluoro-polymer-free.

17. The sliding bearing composite material according to claim 1, wherein the run-in layer is the polymer-based slip varnish layer having a thickness of less than 10 μm, the varnish layer being applied as solution with dissolved PAI.

18. A plain bearing half liner comprising a sliding bearing composite material, the composite material comprising:
a carrier layer of steel;
a copper-based bearing metal layer applied to the carrier layer of steel;
an aluminum-based running layer sputtered on the bearing metal layer; and
a run-in layer applied to the aluminum based running layer, the run-in layer being one of the following: a zinc-phosphate layer having a thickness of about 1-5 μm formed on the surface of the running layer, a layer of tin, bismuth, silver, or alloys thereof having a thickness of about 1-5 μm sputtered on the surface of the running layer, and a polymer-based slip varnish layer having a thickness of less than 10 μm.

19. The plain bearing half liner according to claim 18, wherein the plain bearing half liner is installed in a combustion engine as one of a connecting rod bearing shell and a crankshaft bearing bush.

20. A sliding bearing bush manufactured from a sliding bearing composite material, the composite material comprising:
a carrier layer of steel;
a copper-based bearing metal layer applied to the carrier layer of steel;
an aluminum-based running layer sputtered on the bearing metal layer; and
a run-in layer applied to the aluminum based running layer, the run-in layer being one of the following: a zinc-phosphate layer having a thickness of about 1-5 μm formed on the surface of the running layer, a layer of tin, bismuth, silver, or alloys thereof having a thickness of about 1-5 μm sputtered on the surface of the running layer, and a polymer-based slip varnish layer having a thickness of less than 10 μm.

21. The sliding bearing bush according to claim 20, wherein the sliding bearing bush is installed in a combustion engine as a connecting rod bearing bush.
